(19) United States
(12) Patent Application Publication
(10) Pub. No.: US 2007/0031229 A1
(43) Pub. Date: Feb. 8, 2007

(54) Hay bale transporter

(76) Inventor: Malcolm Murfitt, Victoria (AU)

Correspondence Address: TRASK BRITT, P.O. BOX 2550, SALT LAKE CITY, UT, 84110, US

(21) Appl. No.: 11/496,975

(22) Filed: Aug. 1, 2006

Related U.S. Application Data
(63) Continuation of application No. PCT/AU05/00096, filed on Jan. 31, 2005.

(30) Foreign Application Priority Data
Jan. 29, 2004 (AU) 2004200315

(51) Int. Cl. B60P 1/00

(52) U.S. Cl. 414/555

(57) ABSTRACT

An agricultural transporter (1) for carrying discrete items is described, the transporter (1) having an elongate tray (20) having a front end and a rear end, a wheel means to support the tray (20), wherein the tray (20) comprises a plurality of rollers (26) to enable the conveyance of the items from one part of the tray (20) to another part. In another embodiment, a transporter is described that includes a bale wrapper mounted to the side of the transporter.

### CROSS-REFERENCE TO RELATED APPLICATIONS

This application is a continuation of PCT International Patent Application No. PCT/AU2005/000096, filed on Jan. 31, 2005, designating the United States of America, and published, in English, as PCT International Publication No. WO 2005/072511 A1 on Aug. 11, 2005, which application claims priority to Australian Patent Application No. 2004200315 filed Jan. 29, 2004, the contents of the entirety of each of which are incorporated herein by this reference.

### TECHNICAL FIELD

This invention relates to an agricultural transporter and, more particularly, to an agricultural trailer adapted for articulated attachment to a prime mover such as a tractor.

### BACKGROUND

Agricultural transporters, particularly in the form of trailers, known to the applicant that were available prior to the invention include a static tray surface used for the transfer of discrete items, such as hay bales, from one part of the transporter to another part. Agricultural trailers have been described that include rails or tracks along which the bales may slide. However, the sliding of such items may still involve significant frictional resistance and may make the movement of items on the transporter impractical.

The above references to and descriptions of prior proposals or products are not intended to be, and are not to be construed as, statements or admissions of common general knowledge in the art in Australia or elsewhere.

### DISCLOSURE OF THE INVENTION

Accordingly, in one aspect, the invention provides an agricultural transporter for carrying discrete items, the transporter having:
(a) an elongate tray having a front end and a rear end; and
(b) wheel means to support the tray; and
wherein the tray comprises a plurality of rollers to enable the conveyance of the items from one part of the tray to another part.

Preferably, the transporter is in the form of a trailer having a hitch for articulated attachment to a prime mover. In particular, in another inventive aspect, the prime mover may comprise the front half of an articulated tractor. An articulated tractor includes a motor driven front half articulated to a rear half that provides a steering mechanism. The steering mechanism of an articulated tractor includes the articulated joint providing a turning point for the rear half to turn relative to the front half and a hydraulic ram offset from the turning point. The expansion or contraction of the ram is operative in order to vary the spacing between the front and rear halves on that side of the turning point, whereby to turn the whole front half and effectively provide a mechanism for steering. The invention utilizes this arrangement by substituting the trailer of the invention (or any other compatible trailer used in industry, particularly the agricultural industry) for the rear half of the articulated tractor. The trailer is hitched to the articulated pivot point of the tractor and the resulting vehicle is steered by the combined operation of the front tractor half's pivot point and the hydraulic ram.

Preferably, the rollers are arranged parallel to one another. However, the rollers may be aligned at varying angles relative to one another, for example, where an item is to be moved through an arc or around a corner. Therefore, the rollers may vary in diameter along their lengths to facilitate to movement of an item through an arc. Preferably, however, the rollers are of substantially constant cross-sectional diameter whereby their external shape is substantially elongate and cylindrical. Preferably, the rollers are aligned laterally relative to the longitudinal axis of the transporter and are mounted for rotation about parallel horizontal axes in elongate beams extending the length of the tray and forming part of a frame structure in turn forming part of the tray. Preferably, the rollers rotate freely. However, at least one of the rollers may be driven or the transporter may include a number of spaced driven rollers interposed by one or more freely rotating rollers. The driven rollers may be driven by a continuous drive chain or belt, conveyor belt to cover the rollers, or other suitable means.

Preferably, the transporter includes tray tilt means for dispensing the items from the transporter. Preferably, the tray tilt means lifts the front end of the tray thereby allowing the items to slide off under the impetus of gravity. However, where the items are stackable hay bales, the tray tilt means may be capable of dispensing the items into stacked columns or piles. For this purpose, the tray tilt means may be capable of tilting the tray to substantially 90° relative to the ground surface whereby to off load the items in a neatly stacked configuration. It will be appreciated that a side tray tilt means could, in some circumstances, be preferred to a front end lifting means and a side tray tilt means is considered within the scope of this invention. The tray tilt means may include any suitable lifting means, such as pneumatic or hydraulic rams and/or mechanical linkages.

Preferably, the transporter includes side wall plates that are movable onto the rollers whereby to form a flat tray floor surface. The side wall plates may be permanently affixed to the transporter, such as by hinge means affixed to the sides of the tray. The side wall plates may be made from a variety of panel materials. Particularly preferred is chequer plate steel.

Preferably, the transporter includes side wall supports adapted to receive removable wall barriers extending part or all of the length of the tray. The side wall supports may be used to support the side wall plates in the upright position to expose the rollers. The removable wall barriers may be elongate rails extending between the side wall supports in order to retain items on the wall plate covered tray out of the hay baling season. Accordingly, the movable side wall plates provide utility for the transporter, both in the hay baling season and in general use around a farm at other times of the year.

Preferably, the transporter further includes a hay bale wrapper mounted to one side of the transporter. Hay bale wrappers are typically directly towed by a prime mover such as a tractor. However, heretofore, hay bale wrapping machines have not been mounted onto a hay carting trailer, whether at the side of the trailer, the end or in any other position on the trailer. The reasons that such an arrangement has not been adopted are manifold, but primarily the combination has previously been considered to be cumbersome and unworkable.

Accordingly, in another aspect of the invention, there is provided a hay bale wrapper including:
a) mounting means for attachment to a hay carting transporter and bale wrapping means;
b) height adjustment means for lowering bale support means of the wrapper to ground level to collect a hay bale and raising the bale support means to the level of the tray of the transporter; and
c) tip means to transfer the bale once wrapped from the wrapper to the tray.

Preferably, the bale wrapper includes spaced rollers adapted to rotate the hay bale. The spaced rollers may be mounted within a wrapper frame and preferably extend horizontally in a configuration similar to the spaced tines of a fork lift. The spaced rollers may include a roller surface having a texture or configuration adapted to frictionally engage with the hay bale in order to effectively rotate it upon rotation of the spaced rollers. For example, the spaced roller surface of at least one of the rollers may be a rubber material having the properties of wear resistance and a high frictional surface. Alternatively, the spaced rollers may include ribs, grooves, or ridges capable of frictionally engaging the hay bale to ensure its rotation upon rotation of at least one of the spaced rollers. One of the spaced rollers may be made from low frictional material, such as iron or steel. The spaced rollers may be the same as the plurality of tray rollers.

Preferably, the bale wrapper includes a wrapping arm operable to rotate about a hay bale to apply a protective wrap thereto. The bale wrapper may include a horizontal boom from which the vertical wrapping arm depends. The wrapper arm may be driven and include an upper horizontal arm of sufficient length to space a downwardly depending arm attached to the outer end of the upper arm from the extremities of the hay bale in order to be rotatable completely around the hay bale.

Accordingly, the bale wrapper may include a frame that supports the spaced rollers and to which the mounting means, height adjustment means and the tip means are attached. The frame may include a vertical pillar from which extends the horizontal boom from which a driven L-shaped wrapping arm rotatably depends. The spaced rollers may be adapted to rotate the bale about a generally horizontal axis, while the wrapping arm having the vertical orbiting arm effects the wrapping of the bale by rotating about a vertical axis.

The hay bale wrapper may be mounted to the underside of the transporter. The mounting means may include quick release connections. Quick release connections may include eyelet lugs welded or otherwise mounted onto the trailer, for example, to the height adjustment means, and to the wrapping table and a pin releasably insertable through the eyelets to join the eyelet lugs in a fixed connection. The lifting apparatus, such as a hydraulic ram, may be connected between the wrapping table (or other attachment such as fork lift) to the transporter by a quick release coupling. Such male/female quick release hose couplings are commercially available and will be known to the skilled person.

Different wrapping tables may be incorporated in the hay bale wrapper to suit different sized and shaped bales. The hay bale wrapper may include a turntable wrapper such as the sila wrapper from Knurvaland or the McHale wrapper, for example. Other bale wrapper table arrangements known to the skilled person are considered to fall within the scope of the agricultural transporter of the present invention.

### BRIEF DESCRIPTION OF THE DRAWINGS

The invention may be better understood from the following non-limiting description of one or more preferred embodiments, in which:

FIG. 1 is a perspective view of an agricultural transporter in the form of a trailer according to one embodiment of the present invention; and

FIG. 2 is a perspective view of the transporter of the first embodiment from a different perspective.

### DETAILED DESCRIPTION OF THE INVENTION

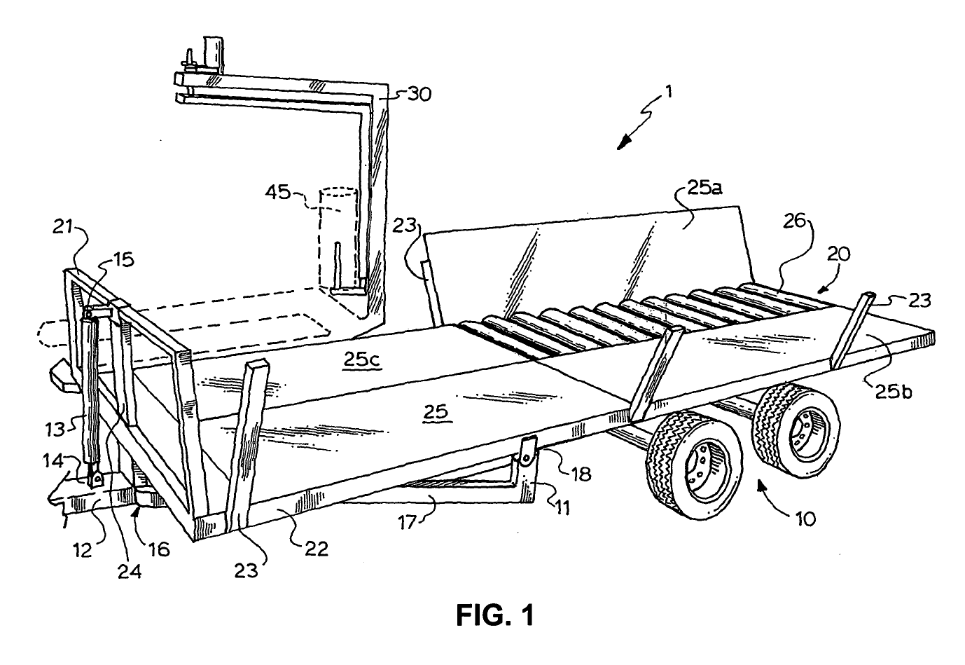

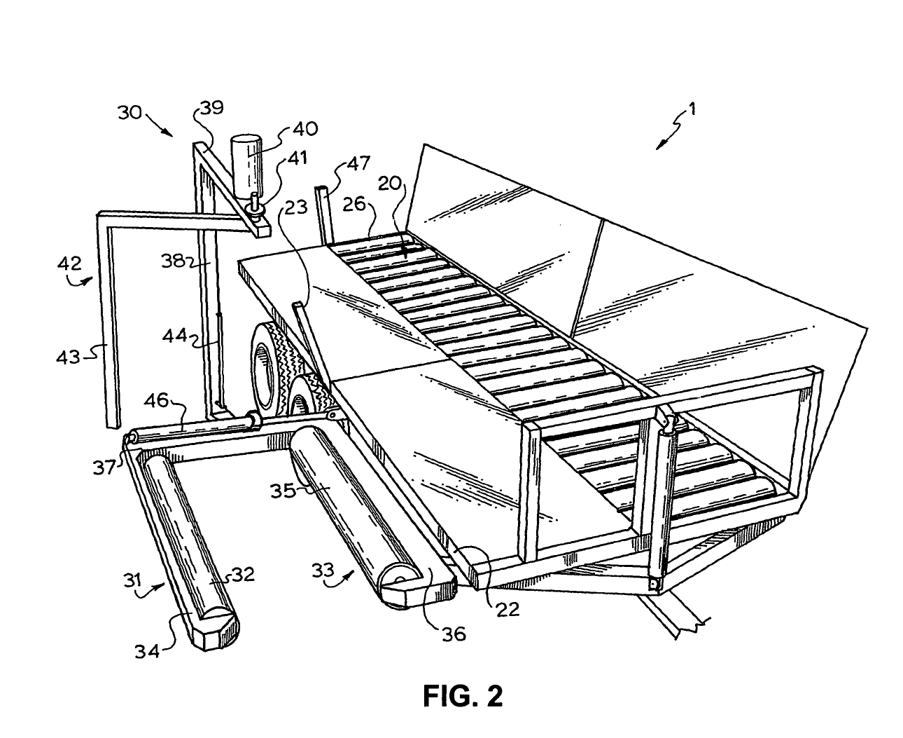

In FIGS. 1 and 2, there is shown an agricultural transporter in the form of a trailer 1. The transporter can, of course, be in the form of a driven transporter such as a truck with an open or walled tray. In the preferred form, the transporter is a trailer 1 having a dual axle arrangement 10.

The trailer 1 includes a tray 20 having a rectangular frame 22 extending about its periphery. The front of the tray is supported by a draw bar 12. The draw bar 12 is straddled by a slot 16 formed in the front apex of the A-frame drawbar 11. The slot 16 is defined by the underside of the pillar 24 and the angled arms 17 of the frame 11. The draw bar 12 is fixed to the tray 20 through a hydraulic ram 13 articulated between the draw bar at hinge 14 and an upright stand 21 extending from the rectangular frame 22 at an upper hinge 15. Accordingly, the tray 20 is able to be lifted relative to the draw bar 12 by extending the hydraulic ram 13. At its fullest extent, the hydraulic rain 13 is adapted to lift the tray 20 to a point where the tray is normal to the ground. The angled arms 17 of the frame 11 extend from the slot 16 out to the sides of the rectangular frame 22 where they are fixed either side of the tray 20 at articulated joints 18.

The articulated joints 18 are the hinge or pivot points of the draw bar frame 11 for tipping the tray 20 by actuating the hydraulic ram 13. The frame 11 comprises in integral form the following components: the draw bar 12, the slot 16 and the angled arms 17, all components being bolted or welded together to form a rigid structure.

Side wall supports 23 are provided on the rectangular frame 22 to support the side wall plates 25 when they are upright as shown for wall plate 25a. The wall plates 25 are hinged to the rectangular frame 22 so that they may be easily moved between the wall position 25a and a floor position 25b. A fourth floor plate 25c is non-hingedly provided adjacent a bale wrapping machine 30 attached to the side of the trailer 1. The floor plate 25c is completely removable when the bale wrapper 30 is in operation. When the trailer 1 is used for general purposes outside the hay baling season, the floor plate 25c is placed in position on the floor as shown so that the trailer 1 can be used for carting items requiring a solid tray floor. The angled wall supports 23 extend at an inclination of about 10 to 20° to the vertical so that the weight of the wall plates 25 keeps them in place against the supports 23 in general use. However, where the trailer 1 is likely to be used in rough terrain or the wall plates 25 are made of a relatively light material that might be displaced from their upright position in general use, then a simple clamp or latch mechanism may be provided to secure the wall plates 25 in place. When the wall plates 25 are used as a floor for the tray 20 so that they are folded down and lay horizontal, the trailer 1 may further be provided with removable rails (not shown) extending between the upright supports 23 to retain the items to be transported by the trailer 1.

The tray 20 includes a plurality of rollers 26 extending laterally between the side beams of the rectangular frame 22. The rollers 26 are mounted for rotation about horizontal axes on brackets welded or bolted to the rectangular frame 22 side beams. Preferably, the rollers 26 are not driven but are freely rotatable. The rollers may be hollow metal or plastic cylinders and may have an abrasion-resistant surface, such as rubber or a tough polymeric surface such as polypropylene or polycarbonate. However, a plain metal surface will perform adequately in most applications. The rollers 26 are preferably spaced to permit free rotation and to minimize the overall weight of the trailer 1. For example, the spacing between each roller 26 may be between 100 and 200% of the diameter of each of the rollers 26. The rollers 26 may be identical or may vary depending on their position on the trailer 1. Preferably, the rollers 26 are identical to keep manufacturing costs and design variation to a minimum.

Attached integrally to the front of the draw bar 12 is an extendable hitch or coupling 50 for connecting the trailer to a prime mover, tractor, etc. The hitch 50 extends in and out. Contraction is for more efficient storage or transport. Extension is for towing and/or when the trailer is in use.

Referring specifically to FIG. 2, removably attached to the side of the trailer 1 is the bale wrapper mechanism 30. The bale wrapper 30 is mounted to the side of the trailer 1 by height adjustment means that may be in the form of one or more hydraulic rams and/or a multiple link mechanism. The height adjustment means is operable to lower the bale wrapper 30 so that the wrapper frame 31 rests on the ground. The wrapper frame 31 is in the shape of a horizontal U on which is mounted a pair of spaced bale rollers 32, 33. The outer roller 32 is identical to the rollers 26 and is adapted to freely rotate about its axle mounted on an outer arm 34 of the wrapper frame 31. The inner roller 33 is of a larger diameter due to an outer rubber layer 35 adapted to better grip the bale. The inner roller 33 is driven by a motor (not shown) housed within the inner arm 36 of the wrapper frame 31.

Extending from the bridge 37 of the wrapper frame 31 is a vertical pole 38. The upper end of the pole 38 terminates with a horizontal boom 39 fixed to the pole 38 and extending over the wrapper frame 31 at a mid point of the foot print of the wrapper frame 31. Mounted on the boom 39 is a motor 40 having a belt or chain drive adapted to drive vertical axle 41. Alternatively, the bale wrapper 30 may be mounted so that the boom 39 extends from the front of the trailer.

On the underside of the boom 39 and rotatably attached to the axle 41 is an inverted L-shaped arm 42 having a vertical arm 43 adapted to orbit a hay bale to be wrapped by the bale wrapper 30. Mounted at the base of the vertical pole 38 is a film roll holder 44.

In use, the trailer 1 is driven alongside a hay bale to be wrapped resting on the ground. Hay bales should be wrapped shortly after formation. For example, in warmer climates, it is desirable to wrap hay bales within two hours of formation, whereas in colder climates a longer delay is not critical provided the bales remain dry.

The bale wrapper 30 is lowered so that the wrapper frame is aligned close to the ground so that the inner and outer arms 34, 36 can be slid like fork lift tines under and around the hay bale. Once the hay bale is located on the wrapper rollers 32, 33, the wrapping process may be commenced once the bale wrapper 30 is lifted so that the rollers 32, 33 are lifted up to the same level as the tray 20. The roller 33 rotates, thereby tumbling the hay bale (not shown). Where the hay bale is cylindrical in shape (“round”), the tumbling motion will typically be end on end (i.e., about an axis transverse to the longitudinal axis), rather than rotation being through its longitudinal axis. The film roller holder 44 supports a roll of film 45 (see FIG. 1) that is applied in multiple layers to the hay bale by the orbiting action of the vertical arm 43 so that the hay is completely sealed within the film 45. Preferably, the bale wrapper 30 applies about two layers of film 45 to ensure a satisfactory seal, although in some applications, up to four layers may be desirable. The bale wrapper 30 preferably further includes film cutting means and film tying means to prevent unraveling of the wrap.

The bale wrapper 36 includes a lifting frame 51 on which is mounted a wrapping table incorporating the wrapper frame 31. The wrapping table is mounted by connections underneath the side of the trailer 1 to enable the quick connection of different types of wrapping tables, such as the wrapping table shown in FIG. 2 or a turntable sila wrapper sold by Knurvaland or the McHale turntable wrapper, etc. The trailer 1 can also support the mounting of a square bale loader to the trailer, such as on the side or end of the trailer 1.

Quick release connections include eyelet lugs welded onto the hydraulic lifting frame in turn mounted to the underside of the trailer. Corresponding eyelet lugs are welded to the side of the wrapping table. A pin releasably insertable through the eyelets can be used to join the respective eyelet lugs in a fixed connection. The connection comprises a pair of sets of eyelet lugs spaced along the opposing sides of the trailer and the alternate wrapping tables. The connection is quickly released by removal of the pins so that another wrapping table can be substituted.

Also shown are hydraulic rams 52 and 53. Hydraulic ram 52 is adapted to lift the lifting frame 51 to raise and lower the bale wrapper 30. Hydraulic ram 53 is adapted to tilt the lifting frame 51 to tilt hay bales onto the tray 20 and to maintain the bale wrapper 30 in the tilted position for transport or storage of the trailer 1. Pivot points 54 about which the tiltable frame 51 tilts are shown.

On completion of the wrapping process, the bale wrapper 30 is tilted towards the tray 20 by the operation of a tip means in the form of a hydraulic ram 46 extending along the bridge 37 and anchored by hinge means at the fixed end of the outer arm 34 and to the rectangular frame 22 so that the wrapped hay bale is tipped onto the tray 20. All rollers 26 are exposed in this operation as all wall plates 25 are in the wall position resting against the wall supports 23. As the trailer 1 progresses under the drive of the prime mover, the bale rolls over the rollers 26 down to the rear end of the trailer 1 where a removable barrier 28 prevents the bale from rolling off the end of the trailer 1. In some eases, it may be necessary for the bale to be manually moved down to the rear end of the tray. By this process, a plurality of bales may be wrapped and loaded onto the trailer 1 to be carted to a storage facility or location. At the storage facility or location, the tray may be tipped to its full extent by the operation of the ram 13 whereby the tray assumes a near vertical orientation, permitting the hay bales to slide off the rear of the trailer 1 (the rear barrier 47 having been removed or folded so as not to be an obstruction) and the bales may be stacked neatly without further handling. The ram 13 is then retracted so that the tray once again assumes its horizontal position for transport. At other times of the year, it may be desirable to use the transporter for carting items such as wrapped hay bales, agricultural machinery, etc., and the transporter is adapted for this multiple purpose by the provision of the wall plates 25 being folded down and forming a solid floor surface.

When used in this specification and claims, the terms “comprises” and “comprising ” and variations thereof mean that the specified features, steps or integers are included. The terms are not to be interpreted to exclude the presence of other features, steps or components.

It is to be understood that various alterations, modifications and/or additions may be made to the features of the possible and preferred embodiment(s) of the invention as herein described without departing from the spirit and scope of the invention.

1. An agricultural transporter for carrying one or more items, the transporter having:
a) an elongate tray having a front end and a rear end;
b) wheel means to support the tray; and
c) a bale wrapper having:
i) mounting means for attachment of the bale wrapper to the transporter;
ii) support means for collecting and supporting the item;
iii) bale wrapping means;
iv) height adjustment means for lowering the support means to ground level to collect the item off the ground and to raise the support means to the level of the tray; and
v) tip means to transfer the item from the bale wrapper to the tray.

2. The transporter of claim 1, wherein the transporter further includes tray tilt means for lilting the front end of the tray whereby to facilitate the removal of the items from the tray.

3. The transporter of claim 2, wherein the tray tilt means is capable of tilting the tray to a position substantially normal to the ground surface whereby to off-load the items in a neatly stacked configuration.

4. The transporter of claim 1, wherein the tray comprises a plurality of rollers to enable the conveyance of the items from one part of the tray to another part.

5. The transporter of claim 4, wherein the transporter further includes side wall plates which are movable onto the rollers whereby to form a flat tray surface.

6. The transporter of claim 1, wherein the transporter includes side wall supports that support removable wall barriers which, when in place on the side wall supports, extend part or all of the length of the tray.

7. The transporter of claim 1, wherein the hay bale wrapper is mounted to one side of the transporter.

8. The transporter of claim 1, wherein the support means includes a fork comprising a pair of spaced arms aligned parallel to the tray in the general direction of travel to receive between the spaced arms the item from the ground.

9. The transporter of claim 8, wherein the spaced arms include rollers rotatable to rotate the item to facilitate wrapping of the item by the bale wrapper.

10. The transporter of claim 1, in the form of a trailer hitchable to a prime mover that is the front half of an articulated tractor and the front tractor half is steerable by means of an hydraulic ram offset relative to the hitch and coupled to the front tractor half and the trailer.

11. The transporter of claim 2, in the form of a trailer hitchable to a prime mover that is the front half of an articulated tractor and the front tractor half is steerable by means of an hydraulic ram offset relative to the hitch and coupled to the front tractor half and the trailer.

12. The transporter of claim 3, in the form of a trailer hitchable to a prime mover that is the front half of an articulated tractor and the front tractor half is steerable by means of an hydraulic ram offset relative to the hitch and coupled to the front tractor half and the trailer.

13. The transporter of claim 4, in the form of a trailer hitchable to a prime mover that is the front half of an articulated tractor and the front tractor half is steerable by means of an hydraulic ram offset relative to the hitch and coupled to the front tractor half and the trailer.

14. The transporter of claim 5, in the form of a trailer hitchable to a prime mover that is the front half of an articulated tractor and the front tractor half is steerable by means of an hydraulic ram offset relative to the hitch and coupled to the front tractor half and the trailer.

15. The transporter of claim 6, in the form of a trailer hitchable to a prime mover that is the front half of an articulated tractor and the front tractor half is steerable by means of an hydraulic ram offset relative to the hitch and coupled to the front tractor half and the trailer.

16. The transporter of claim 7, in the form of a trailer hitchable to a prime mover that is the front half of an articulated tractor and the front tractor half is steerable by means of an hydraulic ram offset relative to the hitch and coupled to the front tractor half and the trailer.

17. The transporter of claim 8, in the form of a trailer hitchable to a prime mover that is the front half of an articulated tractor and the front tractor half is steerable by means of an hydraulic ram offset relative to the hitch and coupled to the front tractor half and the trailer.

18. The transporter of claim 9 in the form of a trailer hitchable to a prime mover that is the front half of an articulated tractor and the front tractor half is steerable by means of an hydraulic ram offset relative to the hitch and coupled to the front tractor half and the trailer.
